(19) United States
(12) Patent Application Publication
(10) Pub. No.: US 2026/0319445 A1
(43) Pub. Date: Oct. 15, 2026

(54) INDUSTRIAL DATA HYBRID MODEL CONSTRUCTION METHOD AND SYSTEM FOR DISCRETE MANUFACTURING

(71) Applicant: Nanjing University of Posts and Telecommunications, Nanjing (CN)

(72) Inventors: Haigen YANG, Nanjing (CN); Xiaolin ZHANG, Nanjing (CN); Erhan DAI, Nanjing (CN); Yan GE, Nanjing (CN); Jixin LIU, Nanjing (CN); Fanyu ZENG, Nanjing (CN)

(21) Appl. No.: 19/695,705

(22) Filed: Jun. 2, 2026

Related U.S. Application Data
(63) Continuation of application No. PCT/CN2025/073820, filed on Jan. 22, 2025.

(30) Foreign Application Priority Data
Oct. 15, 2024 (CN) 202411435720.0

(51) Int. Cl. G05B 13/02

(52) U.S. Cl. CPC G05B 13/0265

(57) ABSTRACT

An industrial data hybrid model construction method and system for discrete manufacturing. The method comprises: firstly, collecting discrete manufacturing industrial data in real time, and performing feature extraction to obtain a feature vector; then, separately inputting feature data into a first model and a second model to obtain a first output and a second output; and performing weighted summation on the first output and the second output to obtain an industrial data hybrid model. The first model is used for obtaining a fitting curve of the feature data in a discrete space, and the second model is used for using a decision tree as a weak learner to perform ensemble learning on the feature data. Regarding the characteristic of service scenarios in the discrete manufacturing industry being complex and variable, the flexibility of intelligent data inference is improved.

### TECHNICAL FIELD

The present disclosure relates to the field of intelligent inference, and in particular to an industrial data hybrid model construction method and system for discrete manufacturing.

### BACKGROUND

With the discrete manufacturing industry entering the era of digital transformation, data-driven intelligent inference has become a key to improving production efficiency and quality and reducing energy consumption. In the discrete manufacturing industry, data may come from a plurality of sources, including sensors, equipment, production lines, etc. Moreover, in a manufacturing environment, a plurality of decisions require real-time responses, not just analysis of historical data. Conditions in an industrial environment may also be constantly changing, and an inference system is required to continuously optimize performance in a changing environment to adapt to new processes and requirements. The manufacturing industry usually involves complex production processes with a plurality of links and stages. Therefore, discrete manufacturing industrial data has the characteristics of being multi-source heterogeneous, massive, high-dimensional, multi-scale, and multi-spatiotemporal, and requiring high real-time performance. Establishing an accurate model to infer about these complex processes is very challenging.

Conventional data intelligent inference methods are generally relatively static and simple, making it difficult to flexibly adapt to dynamically changing environments and problems. For application scenarios with high real-time requirements, conventional methods may appear insufficiently flexible. They perform well for a single type of industrial data, but when the data sources are multi-source data or multi-spatiotemporal multi-scale data, it is necessary to continuously and manually update rules and logic or select a more appropriate model, which makes data inference based on conventional models less flexible.

### SUMMARY

Objective: An objective of the present disclosure is to provide a reinforcement learning-based hybrid model construction method and system for intelligent inference of discrete manufacturing industrial data, so as to solve the problems of multi-source heterogeneity and multi-scale of discrete manufacturing industrial data.

Technical solution: An industrial data hybrid model construction method for discrete manufacturing according to the present disclosure includes the following steps:
collecting discrete manufacturing industrial data in real time, and performing feature extraction to obtain a feature vector;
separately inputting feature data into a first model and a second model to obtain a first output and a second output; and
performing weighted summation on the first output and the second output to obtain an industrial data hybrid model; where
the first model is configured to obtain a fitting curve of the feature data in a discrete space, and the second model is configured to use a decision tree as a weak learner to perform ensemble learning on the feature data.

Further, the first model calculates an output y₁ᵢ=l+w^{t}φ(xᵢ) for each input feature vector; in the formula, l represents an industrial loss, w^{t} represents a weight vector of the input vector, φ represents a high-dimensional feature space, and xᵢ represents the input feature vector, i=1, 2, . . . n;

l and w^{t} are obtained through solving by minimizing l, and constraints satisfied during the solving process are as follows:

$$[ \begin{matrix}min \frac{1}{2} {‖ w ‖}_{2}^{2} + B {\sum }_{i = 1}^{n} {e}_{i} \\ y - ( {w}^{t} φ ( {x}_{i} ) + l \leq ε + {e}_{i} \\ {e}_{i} \geq 0\end{matrix} ;$$

in the formula, B represents a penalty term, y represents an actual target value of a sample, w represents a weight vector, ε represents a threshold of a tolerable error, and eᵢ represents a slack variable.

Further, the second model calculates an output

$${y}_{2 i} = {\sum }_{K = 1}^{K} {f}_{K} ( {x}_{i} )$$

for each input feature vector, f_{K}(xᵢ)∈R; in the formula, K represents the number of weak learners, R represents an original feature space of the discrete manufacturing industrial data, and xᵢ represents the input feature vector, i=1, 2, . . . n; f_{K} represents a function in R, representing a model of a K^{th} tree being trained; and
an objective function of the second model is

$$X = {\sum }_{i = 1}^{n} loss + {\sum }_{k = 1}^{k} γ M + C \frac{1}{2} {\sum }_{j = 1}^{M} {ω}_{j}^{w} ,$$

and tree models are added iteratively to minimize the objective function; in the formula, loss represents a loss of a discrete manufacturing industrial data set, M and

$${ω}_{j}^{w}$$

represent the number of child nodes of a decision tree and a weight thereof, and C represents a penalty coefficient.

Further, the hybrid model is Y=w₁y₁+w₂y₂; in the formula, y₁ represents the first output, w₁ represents a weight of the first output, y₂ represents the second output, and w₂ represents a weight of the second output.

Further, the weight w₁ of the first output and the weight of the second output w₂ are calculated using a least squares weight fusion method.

Further, parameters of the hybrid model are evaluated by means of an R² index.

An industrial data hybrid model construction system for discrete manufacturing according to the present disclosure includes:
a feature extraction unit configured to collect discrete manufacturing industrial data in real time, and perform feature extraction to obtain a feature vector;
a data processing unit configured to separately input feature data into a first model and a second model to obtain a first output and a second output; where the first model is configured to obtain a fitting curve of the feature data in a discrete space, and the second model is configured to use a decision tree as a weak learner to perform ensemble learning on the feature data; and
a hybrid model building unit configured to perform weighted summation on the first output and the second output to obtain an industrial data hybrid model.

Further, the first model calculates an output y₁ᵢ=l+w^{t}φ(xᵢ) for each input feature vector; in the formula, l represents an industrial loss, w^{t} represents a weight vector of the input vector, φ represents a high-dimensional feature space, and xᵢ represents the input feature vector, i=1, 2, . . . n;
l and w^{t} are obtained through solving by minimizing l, and constraints satisfied during the solving process are as follows:

$$[ \begin{matrix}min \frac{1}{2} {‖ w ‖}_{2}^{2} + B {\sum }_{i = 1}^{n} {e}_{i} \\ y - ( {w}^{t} φ ( {x}_{i} ) + l \leq ε + {e}_{i} \\ {e}_{i} \geq 0\end{matrix} ;$$

in the formula, B represents a penalty term, y represents an actual target value of a sample, w represents a weight vector, ε represents a threshold of a tolerable error, and eᵢ represents a slack variable;
the second model calculates an output

$${y}_{2 i} = {\sum }_{K = 1}^{K} {f}_{K} ( {x}_{i} )$$

for each input feature vector, f_{K}(xᵢ)∈R; in the formula, K represents the number of weak learners, R represents an original feature space of the discrete manufacturing industrial data, and xᵢ represents the input feature vector, i=1, 2, . . . n; f_{K} represents a function in R, representing a model of a K^{th} tree being trained; and
an objective function of the second model is

$$X = {\sum }_{i = 1}^{n} loss + {\sum }_{k = 1}^{k} γ M + C \frac{1}{2} {\sum }_{j = 1}^{M} {ω}_{j}^{w} ,$$

and tree models are added iteratively to minimize the objective function; in the formula, loss represents a loss of a discrete manufacturing industrial data set, M and

$${ω}_{j}^{w}$$

represent the number of child nodes of a decision tree and a weight thereof, and C represents a penalty coefficient.

An electronic device according to the present disclosure includes a processor, a memory, and a computer program stored on the memory and runnable on the processor, where the computer program, when loaded into the processor, implements the industrial data hybrid model construction method for discrete manufacturing.

A computer-readable storage medium according to the present disclosure stores a computer program, where the computer program, when executed by a processor, implements the industrial data hybrid model construction method for discrete manufacturing.

Beneficial effects: Compared with the prior art, the advantages of the present disclosure are as follows: The present disclosure proposes separately inputting discrete manufacturing industrial data into two models, applying a least squares weight fusion method, and outputting a hybrid model for intelligent inference of discrete manufacturing industrial data. Compared with conventional data intelligent inference methods, the method of the present disclosure is more capable of adapting to dynamically changing environments and problems, and better meets the complex and changeable service scenario requirements of the discrete manufacturing industry.

### BRIEF DESCRIPTION OF THE DRAWINGS

FIG. 1 is a flowchart of a hybrid model construction method according to an embodiment of the present disclosure.

### DETAILED DESCRIPTIONS OF THE EMBODIMENTS

The technical solution of the present invention will be further described below in combination with the drawings.

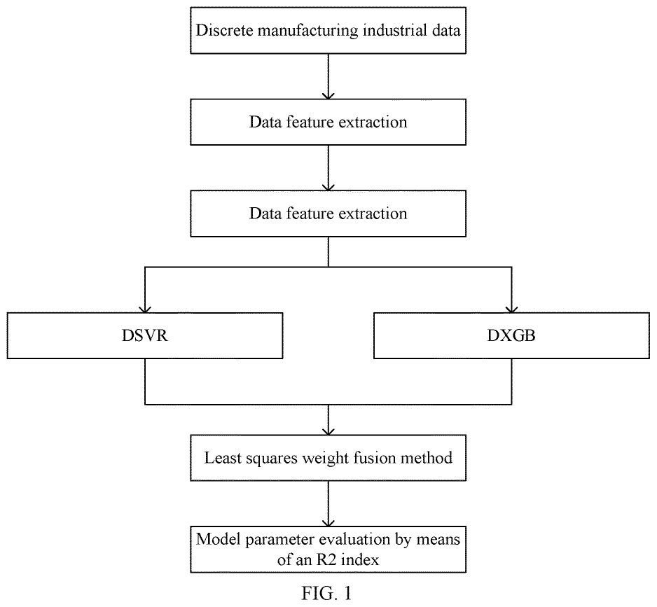

As shown in FIG. 1, an industrial data hybrid model construction method for discrete manufacturing includes the following steps:

S1, discrete manufacturing industrial data is collected in real time (including real-time equipment status data, energy consumption data, lifecycle data, sensor data, production process data, quality data, and the like). The collected data is mapped from an original feature space to a high-dimensional feature space to facilitate fitting.

S2, the discrete manufacturing industrial data are separately processed using a discrete data vector regression (DSVR) algorithm and a discrete data gradient boosting (DXGB) algorithm.

### (1) DSVR Algorithm:

By identifying a curve in a discrete space and keeping all data points as close as possible to the curve, the loss is minimized for subsequent data inference.

y₁ᵢ=l+w^{t}φ(xᵢ); in the formula, l represents an industrial loss, w^{t} represents a weight vector of the input vector, φ represents a high-dimensional feature space, and xᵢ represents the input feature vector.

The purpose of DSVR is to optimize the model by minimizing the loss l, and w^{t} and l are obtained by solving. However, during the solving process, a certain constraint

$$[ \begin{matrix}min \frac{1}{2} {‖ w ‖}_{2}^{2} \\ s . t . \vert y - ( {w}^{t} {s}_{i} + l ) \vert \leq ε\end{matrix}$$

needs to be observed; and ε cannot be set too large or too small. Therefore, a variable eᵢ is set for each sample in DSVR to avoid loss of rationality:

$$[ \begin{matrix}min \frac{1}{2} {‖ w ‖}_{2}^{2} + B {\sum }_{i = 1}^{n} {e}_{i} \\ y - ( {w}^{t} φ ( {x}_{i} ) + l \leq ε + {e}_{i} \\ {e}_{i} \geq 0\end{matrix} ;$$

in the formula, B represents a penalty term, generally set to 1, y represents an actual target value of a sample, w represents a weight vector, i represents a threshold of a tolerable error, and eᵢ represents a slack variable.

### (2) DXGB Algorithm:

A decision tree used as a weak learner, and an integration mode of the learner is

$${y}_{2 i} = {\sum }_{K = 1}^{K} {f}_{K} ( {x}_{i} ) , {f}_{K} ( {x}_{i} ) ∈ R ;$$

in the formula, xᵢ represents an input vector of the i^{th} discrete manufacturing industrial data, K represents the number of weak learners, R represents an original feature space of the discrete manufacturing industrial data, and f_{K} represents a function in R, representing a model of the K^{th} tree being trained. An objective function of DXGB is

$$X = {\sum }_{i = 1}^{n} loss + {\sum }_{k = 1}^{k} γ M + C \frac{1}{2} {\sum }_{j = 1}^{M} {ω}_{j}^{w} ,$$

and tree models are added iteratively to minimize the objective function. loss represents a loss of a discrete manufacturing industrial data set, M and

$${ω}_{j}^{w}$$

represent the number of child nodes and a weight thereof, and C represents a penalty coefficient.

S3, after the discrete manufacturing industrial data is input into the two models, a least squares weight fusion method is applied to obtain combined weights, and the output is the hybrid model: Y=w₁y₁+w₂y₂; in the formula, w₁ represents a weight of DSVR in the hybrid model, and w₂ represents a weight of DXGB in the hybrid model. A loss function is

$$H = {\sum }_{i = 1}^{2} [ ( {y}_{i} - Y ) ] ,$$

satisfying a constraint w₁+w₂=1. The comprehensive weights are optimally solved to minimize the loss function H, i.e., minH, and w₁ and w₂ are obtained simultaneously. In the formula, w₁ represents a weight of DSVR in the hybrid model, and w₂ represents a weight of DXGB in the hybrid model.

S4, parameters of the hybrid model are evaluated by means of an R² index.

$${R}^{2} = \frac{{λ}^{2} - MSE}{{λ}^{2}} ;$$

in the formula, λ² represents a variance, and MSE represents a mean squared error. The closer the R² score is to 1, the better the performance of the hybrid model.

An industrial data hybrid model construction system for discrete manufacturing according to the present disclosure includes:
a feature extraction unit configured to collect discrete manufacturing industrial data in real time, and perform feature extraction to obtain a feature vector;
a data processing unit configured to separately input feature data into a first model and a second model to obtain a first output and a second output; where the first model is configured to obtain a fitting curve of the feature data in a discrete space, and the second model is configured to use a decision tree as a weak learner to perform ensemble learning on the feature data; and
a hybrid model building unit configured to perform weighted summation on the first output and the second output to obtain an industrial data hybrid model.

An electronic device according to the present disclosure includes a processor, a memory, and a computer program stored on the memory and runnable on the processor, where the computer program, when loaded into the processor, implements the industrial data hybrid model construction method for discrete manufacturing.

A computer-readable storage medium according to the present disclosure stores a computer program, where the computer program, when executed by a processor, implements the industrial data hybrid model construction method for discrete manufacturing.

The computer-readable storage medium may include a random access memory (RAM), a read-only memory (ROM), an erasable programmable read-only memory (EPROM), a compact disk read-only memory (CD-ROM) or other optical disk storage, magnetic disk storage or other magnetic storage devices, a flash memory, or any other medium that can be used to store desired program code in the form of instructions or data structures and that can be accessed by a computer.

The processor is configured to execute the computer program stored in the memory to implement the steps of the method involved in the above embodiment.

What is claimed is:

1. A computer-implemented industrial data hybrid model construction method for discrete manufacturing, the method being performed by one or more processors and comprising:
collecting, in real time from a discrete manufacturing environment, discrete manufacturing industrial data, the discrete manufacturing industrial data comprising at least one of equipment status data, energy consumption data, lifecycle data, sensor data, production process data, or quality data;
performing feature extraction on the discrete manufacturing industrial data to obtain feature data comprising a plurality of input feature vectors;
separately inputting the feature data into a first model and a second model to obtain a first output and a second output, respectively; and
performing weighted summation on the first output and the second output to obtain an industrial data hybrid model for intelligent inference of the discrete manufacturing industrial data;
wherein the first model is configured to obtain a fitting curve of the feature data in a discrete space, and the second model is configured to use a decision tree as a weak learner to perform ensemble learning on the feature data;
wherein the first model calculates, for each input feature vector xᵢ, the first output y₁ᵢ according to:
y₁ᵢ=l+w^{t}φ(xᵢ),i=1,2, . . . n,
wherein l represents an industrial loss parameter, w^{t} represents a weight vector corresponding to the input feature vector, φ represents a mapping to a high-dimensional feature space, and xᵢ represents the input feature vector;
wherein l and w^{t} are obtained by minimizing a loss subject to constraints comprising:
$$[ \begin{matrix}min \frac{1}{2} {‖ w ‖}_{2}^{2} + B {\sum }_{i = 1}^{n} {e}_{i} \\ y - ( {w}^{t} φ ( {x}_{i} ) + l ) \leq ε + {e}_{i} \\ {e}_{i} \geq 0\end{matrix} ;$$
wherein, B represents a penalty term, y represents an actual target value of a sample, w represents a weight vector, i represents a threshold of a tolerable error, and eᵢ represents a slack variable;
wherein the second model calculates, for each input feature vector xᵢ, the second output y₂ᵢ according to:
$${y}_{2 i} = {\sum }_{K = 1}^{K} {f}_{K} ( {x}_{i} ) , {f}_{K} ( {x}_{i} ) ∈ R ,$$
wherein K represents a number of weak learners, R represents an original feature space of the discrete manufacturing industrial data, and xᵢ represents the input feature vector (i=1, 2, . . . n), and f_{K} represents a function in R corresponding to a K^{th} decision tree being trained; and
wherein an objective function of the second model is
$$X = {\sum }_{i = 1}^{n} loss + {\sum }_{k = 1}^{k} γ M + C \frac{1}{2} {\sum }_{j = 1}^{M} {ω}_{j}^{w} ,$$
and tree models are iteratively added to minimize the objective function; and wherein loss represents a loss of a discrete manufacturing industrial data set, M and
$${ω}_{j}^{w}$$
represent the number of child nodes of a decision tree and a weight thereof, and C represents a penalty coefficient.

2. The industrial data hybrid model construction method for discrete manufacturing according to claim 1, wherein the hybrid model is Y=w₁y₁+w₂y₂; in the formula, y₁ represents the first output, w₁ represents a weight of the first output, y₂ represents the second output, and w₂ represents a weight of the second output.

3. The industrial data hybrid model construction method for discrete manufacturing according to claim 2, wherein the weight w₁ of the first output and the weight w₂ of the second output are calculated using a least squares weight fusion method.

4. The industrial data hybrid model construction method for discrete manufacturing according to claim 1, wherein parameters of the hybrid model are evaluated by means of an R² index.

5. An industrial data hybrid model construction system for discrete manufacturing, comprising one or more processors and a memory storing instructions that, when executed by the one or more processors, cause the system to perform operations comprising:
collecting, in real time from a discrete manufacturing environment, discrete manufacturing industrial data, the discrete manufacturing industrial data comprising at least one of equipment status data, energy consumption data, lifecycle data, sensor data, production process data, or quality data;
performing feature extraction on the discrete manufacturing industrial data to obtain feature data comprising a plurality of input feature vectors;
separately inputting the feature data into a first model and a second model to obtain a first output and a second output, respectively; and
performing weighted summation on the first output and the second output to obtain an industrial data hybrid model for intelligent inference of the discrete manufacturing industrial data;
wherein the first model is configured to obtain a fitting curve of the feature data in a discrete space, and the second model is configured to use a decision tree as a weak learner to perform ensemble learning on the feature data;
wherein the first model calculates, for each input feature vector xᵢ, the first output y₁ᵢ according to:
y₁ᵢ=l+w^{t}φ(xᵢ),i=1,2, . . . n,
wherein l represents an industrial loss parameter, w^{t} represents a weight vector corresponding to the input feature vector, φ represents a mapping to a high-dimensional feature space, and xᵢ represents the input feature vector;
wherein l and w^{t} are obtained by minimizing a loss subject to constraints comprising:
$$[ \begin{matrix}min \frac{1}{2} {‖ w ‖}_{2}^{2} + B {\sum }_{i = 1}^{n} {e}_{i} \\ y - ( {w}^{t} φ ( {x}_{i} ) + l ) \leq ε + {e}_{i} \\ {e}_{i} \geq 0\end{matrix} ;$$
wherein B represents a penalty term, y represents an actual target value of a sample, w represents a weight vector, ε represents a threshold of a tolerable error, and eᵢ represents a slack variable;
wherein the second model calculates, for each input feature vector xᵢ, the second output y₂ᵢ according to:
$${y}_{2 i} = {\sum }_{K = 1}^{K} {f}_{K} ( {x}_{i} ) , {f}_{K} ( {x}_{i} ) ∈ R ,$$
wherein K represents a number of weak learners, R represents an original feature space of the discrete manufacturing industrial data, and xᵢ represents the input feature vector (i=1, 2, . . . n), and f_{K} represents a function in R, representing a model of the K^{th} tree being trained; and
wherein an objective function of the second model is
$$X = {\sum }_{i = 1}^{n} loss + {\sum }_{k = 1}^{k} γ M + C \frac{1}{2} {\sum }_{j = 1}^{M} {ω}_{j}^{w} ,$$
and tree models are added iteratively to minimize the objective function; and wherein loss represents a loss of a discrete manufacturing industrial data set, M and
$${ω}_{j}^{w}$$
represent the number of child nodes of a decision tree and a weight thereof, and C represents a penalty coefficient.

6. An electronic device for constructing an industrial data hybrid model for discrete manufacturing, comprising:
a processor;
a memory; and
a computer program stored in the memory and executable by the processor,
wherein execution of the computer program by the processor causes the electronic device to perform the computer-implemented industrial data hybrid model construction method for discrete manufacturing according to claim 1.
